(19) United States
(12) Patent Application Publication
(10) Pub. No.: US 2022/0215976 A1
(43) Pub. Date: Jul. 7, 2022

(54) NUCLEAR POWER STATION USING SPENT NUCLEAR FUEL RODS AS NEUTRON SOURCE AND USING THORIUM (Th) AS NUCLEAR FUEL

(71) Applicant: Kozo TAKAHASHI, Tokyo (JP)

(72) Inventor: Kozo TAKAHASHI, Tokyo (JP)

(21) Appl. No.: 17/565,764

(22) Filed: Dec. 30, 2021

(30) Foreign Application Priority Data
Jan. 4, 2021 (JP) 2021-017802

(51) Int. Cl. G21C 19/18

(52) U.S. Cl. CPC G21C 19/18

(57) ABSTRACT

In the present invention, a nuclear power plant using U235 as nuclear fuel is converted into a nuclear power plant that uses spent nuclear fuel rods as the Nt source and that uses Th as nuclear fuel. The nuclear power plant using U235 as nuclear fuel is converted into a nuclear power plant using Th as nuclear fuel.

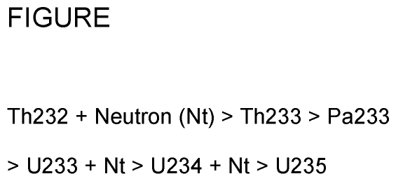

### BACKGROUND OF THE INVENTION

### 1. Field of the Invention

The present invention relates to using an existing nuclear power station (nuclear power plant) that is being shut down or to be shut down and that uses uranium (U235) as nuclear fuel, to provide a nuclear power plant newly using Th as nuclear fuel.

Conventionally, major nuclear power plants mainly use chain reactions of U235.

### 2. Description of the Related Art

[NPL]
Kazuo Furukawa, The Revolution of Safety in Nuclear Power Plants, 2011, BUNGEISHUNJU LTD.

### SUMMARY OF THE INVENTION

Existing nuclear power plants have the following drawbacks.
(i) The construction costs of existing nuclear power plants have been high.
(ii) Large amounts of U235 serving as the main fuel are loaded; U355, which is a radioactive substance that naturally decays, brings about a very dangerous situation in the event of an accident.

The present invention is provided in order to overcome these drawbacks.

A method for replacing fuel rods of a nuclear power station according to the present invention includes, in a nuclear power plant being shut down or a nuclear power plant to be shut down, unloading about a half of or a portion of the existing nuclear fuel rods using U235 as nuclear fuel, and newly loading nuclear fuel rods containing Th as nuclear fuel.

Since 50 or more years ago, it has been said that the major energy source of humans over the next several thousand years will be Th; however, this is not realized at all. The reason for this is as follows.
(i) Th does not spontaneously cause chain reactions and hence the Th atomic nucleus needs to be caused to absorb a neutron (Nt) twice, to be converted into U235. Thus, mixing Th with U235 has been proposed.
(ii) In the case of the former method of mixing with U235, significant differences are not made in costs and safety from existing nuclear power plants.
(iii) In the case of the latter method of incorporating a Nt generation device into a nuclear reactor, the system becomes complicated and causes problems in terms of costs, safety, reliability, and operability.
(iv) In the case of unloading a large portion of existing fuel rods using U235 as the main fuel, and using markedly stable Th as the fuel, the system becomes markedly safe.

### BRIEF DESCRIPTION OF THE DRAWING

[FIGURE]

A sectional view of the present invention is the same as in the boiling or pressurized nuclear power plant.

### DESCRIPTION OF PREFERRED EMBODIMENT

Hereinafter, embodiments according to the invention will be described.
(i) In a case of a nuclear power plant to be shut down, the nuclear power plant is firstly shut down. Subsequently, about a half of or a portion of the nuclear fuel rods are unloaded.
(ii) To the positions from which the fuel rods have been unloaded, fuel rods containing Th as nuclear fuel are loaded.
(iii) In a case of a nuclear power plant being shut down, refueling is performed so as to correspond to about a half of or a portion of the spent nuclear fuel having been unloaded.
(iv) To the vacant loading positions for fuel rods, fuel rods containing Th as nuclear fuel are loaded.
(v) To the vacant loading positions for fuel rods, fuel rods containing Th as nuclear fuel are loaded.
(vi) In both of the case of (i) and (ii) and the case of (iii) and (iv), operation is started as in the ordinary nuclear power plants using U235 as nuclear fuel.

This application claims priority based on Japanese Patent Application No. 2021-017802 filed Jan. 4, 2021, the contents of which are incorporated herein by reference in their entirety.

What is claimed is:

1. A method for replacing fuel rods in a nuclear power station, the method comprising shutting down a nuclear power station being operated, replacing about a half of or a portion of fuel rods used in the nuclear power station by fuel rods containing Th as nuclear fuel, and operating the nuclear power station.

2. A method for replacing fuel rods in a nuclear power station, the method comprising, in a nuclear power station being shut down, refueling about a half of or a portion of fuel rods being used, loading, to remaining loading positions, fuel rods containing Th as nuclear fuel, and starting operation of the nuclear power station.
